(19) United States
(12) Patent Application Publication
(10) Pub. No.: US 2007/0048707 A1
(43) Pub. Date: Mar. 1, 2007

(54) Device and method for determining and improving present time emotional state of a person

(76) Inventors: Ray Caamano, Gilroy, CA (US); Jason Carver, Monterey, CA (US); Cesar Toscano, Cambridge, MA (US); Lawrence Crane, Sherman Oaks, CA (US); Michael J. Lee, Carmel, CA (US); Hans C. Lee, Carmel, CA (US)

Correspondence Address: PRITZKAU PATENT GROUP, LLC, 993 GAPTER ROAD, BOULDER, CO, 80303, US

(21) Appl. No.: 11/500,679

(22) Filed: Aug. 8, 2006

Related U.S. Application Data
(60) Provisional application No. 60/706,580, filed on Aug. 9, 2005.

(51) Int. Cl. G09B 19/00

(52) U.S. Cl. 434/236

(57) ABSTRACT

An exemplary embodiment providing one or more improvements includes determining a measurable characteristic of electrical activity in a user's brain and using the measurable characteristic to determine a present time emotional state of the user.

### RELATED APPLICATIONS

The present application claims priority from U.S. Provisional Application Ser. No. 60/706,580, filed on Aug. 9, 2005 which is incorporated herein by reference. In addition, U.S. patent application Ser. No. XX (Attorney Docket No. EMS-1) titled A Device and Method for Sensing Electrical Activity in Tissue which was invented by Michael Lee et al. nd which has the same filing date as the present application, is hereby incorporated by reference.

### BACKGROUND

Many people experience limiting emotions which prevent them from achieving personal goals in life. These limiting emotions may be a result of accumulated experiences related to the goals or other causes based in the mind of the person. Daily experiences of limiting emotions become accepted as a normal state of being in the person's mind which results in the person experiencing frustration and an ever-increasing resignation that the goals cannot be achieved. The limiting emotions feel real in the nervous system of the person which effects how the person lives their life. When the person is experiencing the limiting emotions due to certain environmental stimulus, the person is reacting. Reacting may also lead to limiting behavior.

A person's mind can be described as a collection of thoughts which serves as a large storage device, similar to a hard drive in a computer. The mind stores the person's experiences and replays past experiences in the form of emotion-laced memories when the person reflects on past experiences. The mind also attaches emotions to present experiences based on the emotions attached to similar past experiences.

Often, when thoughts or memories are unwanted or uncomfortable, the person develops a mental habit of suppressing the memories by pushing them from the present conscious awareness. This causes these thoughts to be stored in the mind and becomes what is known as the subconscious mind. These thoughts accumulate in the subconscious mind and when they reach a significant number in any particular category, or surrounding any particular issue, they become what are known as emotions. These are the emotions which are experienced by the person in everyday life, either randomly or when an appropriate environmental trigger calls them into the person's experience.

Long standing patterns of thought which are accumulated and stored in the sub-conscious mind of a person are called programs. Programs end up creating limiting emotions in the person. Programs are from either attachments or aversions. Attachments are desires to keep certain people, places, things and experiences close to us. An attachment causes the person to experience emotional pain if separated from what the person is attached to. Aversions are desires to keep certain people, places, things and experiences away from us. Fear is a common aversion. The aversion causes the person to experience emotional pain when exposed to situations that the person has an aversion to.

Processes of self or assisted inquiry have been developed to permanently improve the emotional state of the person. One version of these processes was developed by Lester Levenson who made written and recorded audio lectures which describe in detail many of the discoveries on this subject. Another version of these processes was developed by Lawrence Crane and is known as “The Release Technique.”

The Release Technique process involves a mental process called releasing. Releasing is the mental process of letting go of limiting thoughts, though patterns and resulting emotions at the moment they are experienced. The process entails getting a person to bring up a limiting emotion or emotion laden experience, which results in a disturbance in the nervous system. The process guides the individual to normalize the nervous system or release the emotion while the individual is focused on the perceived cause of the disturbance. One of the process guides is called “Attachments and Aversions.”

Freedom is a permanent liberation from the limiting thoughts which have become unwanted emotions experienced as part of the person's ongoing life experience. Freedom is obtained by utilizing the process of releasing over and over until there are no more limiting thoughts stored in the subconscious mind and no more of their resulting limiting emotions experienced in the nervous system. Freedom is a complete liberation of the subconscious mind. Being ness is the person experiencing a natural, inherent state of no limitations, limiting emotions or perceived limitations. Persons who incrementally lower their emotional disturbances experience an ever increasing feeling of oneness, joy, or happiness.

The Release Technique teaches goal setting by requiring users to identify their goal, create goal statements, write them down in a visible place to remind themselves of their goals periodically, check for limiting emotions and release them. The Release Technique guides the person to become aware of their emotions so that they can recognize when they are reacting, then releasing the reactivity, which allows the individual to gain more control over their emotions and over the influence their emotions have on their lives.

While these process guide the person to release limiting thoughts and emotions, these processes do not have a way for the person to objectively verify what it feels like to release the limiting emotions. Without such verification, the person may believe that they are releasing when in fact they are holding on to the limiting emotions.

Another problem that may arise with these processes is that in many cases the processes rely on the person to identify the particular thoughts which are related to the limiting emotions that the person needs to release. Again, since there does not exist a way to objectively measure the release level, there is no way for the person to objectively identify which particular thoughts produce the limiting emotions.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

A method is described for use by a user in which a measurable characteristic of electrical activity (MCEA) in the pre-frontal lobe of the user's brain is predefined which measurably corresponds to a level of certain present time emotional state of the user. The MCEA is isolated from other electrical activity in the user's brain. Media material is provided which when interacted with by the user in a particular way can change the present time emotional state of the user in a way which correspondingly changes the MCEA. The user is caused to interact with the media material in said particular way, and as the user interacts with the media in said particular way, changes are measured in the user's MCEA, if any.

A system is disclosed for use by a given user in which there is established a predefined measurable characteristic of electrical activity (MCEA) in the pre-frontal lobe of the given user's brain that measurably corresponds to a level of certain present time emotional state of the given user. The system includes a media material which when interacted with by the given user in a particular way can change the present time emotional state of the user in a way which correspondingly changes the MCEA. The system also includes means for isolating the MCEA from other electrical activity in the given user's brain, and means for measuring changes in the given user's MCEA, if any, as he or she interacts with the media in said particular way.

A method is also disclosed where a system which involves using media material for guiding a human user to release limiting emotions experienced by the user when the user thinks particular thoughts which causes the user to experience emotional pain. The release is characterized by different levels which are based on how strongly the user experiences the limiting emotions when confronted with the particular thoughts. The user has a greater release level when the user has less limiting emotions related to the particular thoughts and the user has lower release levels when the user has more limiting emotions related to the particular thoughts. An association is predefined between a characteristic of electrical activity in a pre-frontal lobe of a human brain and levels of release that are being experienced. The user is exposed to a stimulus from the media material relating to the particular thoughts at a particular time which causes the user to experience a particular one or more of the limiting emotions. Characteristics of electrical activity in the user's brain are determined at the particular time to establish the level of release at the particular time, and the release level is indicated to the user.

An apparatus is disclosed for use in a system which involves using media material for guiding a human user to release limiting emotions experienced by the user when the user thinks particular thoughts which causes the user to experience emotional pain. The release is characterized by different levels which are based on how strongly the user experiences the limiting emotions when confronted with the particular thoughts. The user has a greater release level when the user has less limiting emotions related to the particular thoughts and the user has lower release levels when the user has more limiting emotions related to the particular thoughts. The apparatus includes a memory device for storing a predefined association between a characteristic of electrical activity in a pre-frontal lobe of a human brain, and levels of release that are being experienced. A sensor circuit is used for sensing the characteristic of electrical activity in a pre-frontal lobe of the user's brain and for generating a signal of interest based on the sensed characteristic. A processor is connected to receive the signal of interest from the sensor and the association from the memory device and to generate a release level signal based on the application of the association to the signal of interest. An indicator is used for receiving the release level signal and indicating the release level to the user.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is an illustration of a system which uses a sensor device which measures electrical activity to determine a present time emotional state of a user.

FIG. 2 is an illustration of a program which contains a display of a level of the present time emotional state of the user and has controls for media material used in guiding the user in relation to the present time emotional state of the

FIG. 3 is a diagram of one example in which the media material guides the user based on the present time emotional state of the user.

FIG. 4 is a diagram of another example in which the media material guides the user based on the present time emotional state of the user.

FIG. 5 is a diagram of yet another example in which the media material guides the user based on the present time emotional state of the user.

FIG. 6 is a perspective view of the sensor device shown in FIG. 1.

FIG. 7 is a block diagram of the sensor device and a computer shown in FIG. 1.

FIG. 8 is a circuit diagram of an amplifier used in the sensor device shown in FIG. 7.

FIG. 9 is a circuit diagram of a filter stage used in the sensor device shown in FIG. 7.

FIG. 10 is a circuit diagram of a resistor-capacitor RC filter used in the sensor device shown in FIG. 7.

FIG. 11 is a circuit diagram of the amplifier, three filter stages and the RC filter shown in FIGS. 8, 9 and 10.

FIG. 12 is a block diagram of a digital processor of the sensor device shown in FIG. 7.

### DETAILED DESCRIPTION

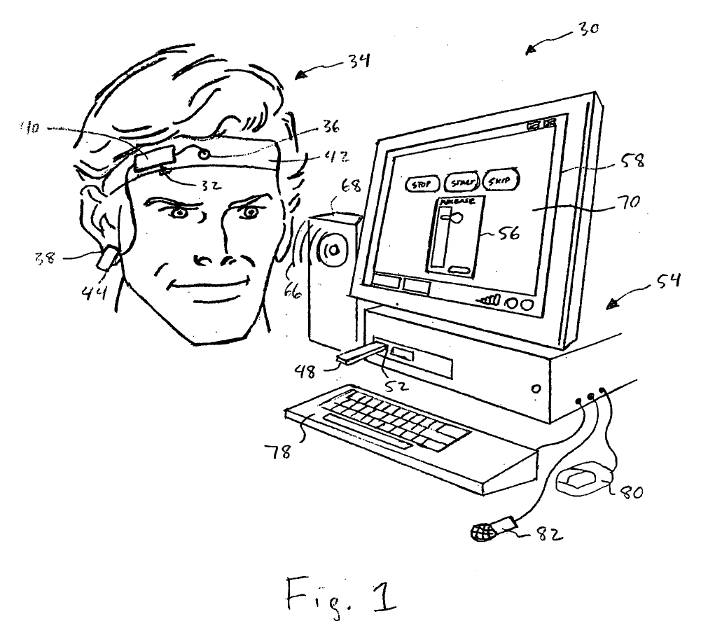

A system 30 which incorporates the present discussion is shown in FIG. 1. Exemplary system 30 includes a sensor device 32 which is connected to a user 34 for sensing and isolating a signal of interest from electrical activity in the user's pre-frontal lobe. The signal of interest has a measurable characteristic of electrical activity, or signal of interest, which relates to a present time emotional state (PTES) of user 34. PTES relates to the emotional state of the user at a given time. For instance, if the user is thinking about something that causes the user emotional distress, then the PTES is different than when the user is thinking about something which has a calming affect on the emotions of the user. In another example, when the user feels a limiting emotion regarding thoughts, then the PTES is different than when the user feels a state of release regarding those thoughts. Because of the relationship between the signal of interest and PTES, system 30 is able to determine a level of PTES experienced by user 34 by measuring the electrical activity and isolating a signal of interest from other electrical activity in the user's brain.

In the present example, sensor device 32 includes a sensor electrode 36 which is positioned at a first point and a reference electrode 38 which is positioned at a second point. The first and second points are placed in a spaced apart relationship while remaining in close proximity to one another. The points are preferably within about 8 inches of one another, and in one instance the points are about 4 inches apart. In the present example, sensor electrode 36 is positioned on the skin of the user's forehead and reference electrode 38 is connected to the user's ear. The reference electrode can also be attached to the user's forehead, which may include positioning the reference electrode over the ear of the user.

Sensor electrode 36 and reference electrode 38 are connected to an electronics module 40 of sensor device 32, which is positioned near the reference electrode 38 to that they are located substantially in the same noise environment. The electronics module 40 may be located at or above the temple of the user or in other locations where the electronics module 40 is in close proximity to the reference electrode 38. In the present example, a head band 42 or other mounting device holds sensor electrode 36 and electronics module 40 in place near the temple while a clip 44 holds reference electrode 38 to the user's ear. In one instance, the electronics module and reference electrode are positioned relative to one another such that they are capacitively coupled.

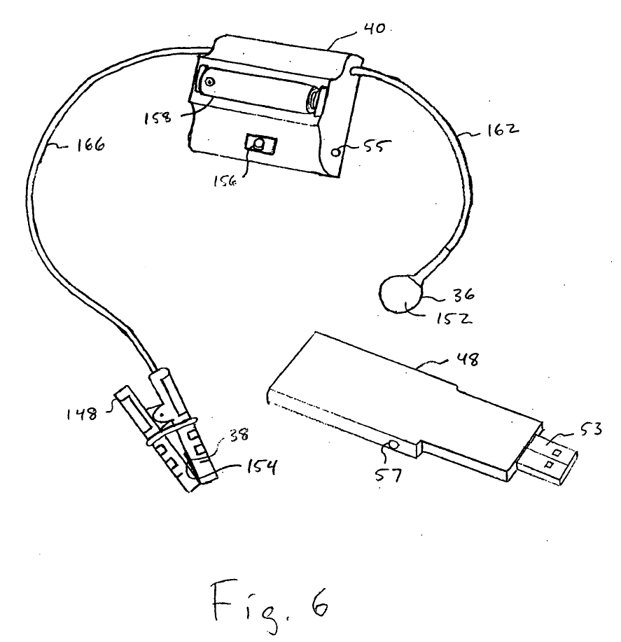

Sensor electrode 36 senses the electrical activity in the user's pre-frontal lobe and electronics module 40 isolates the signal of interest from the other electrical activity present and detected by the sensor electrode. Electronics module 40 includes a wireless transmitter 46, (FIG. 6), which transmits the signal of interest to a wireless receiver 48 over a wireless link 50. Wireless receiver 48, FIG. 1, receives the signal of interest from electronics module 40 and connects to a port 52 of a computer 54, or other device having a processor, with a port connector 53 to transfer the signal of interest from wireless receiver 48 to computer 54. Electronics module 40 includes an LED 55 (FIG. 6), and wireless receiver 48 includes an LED 57 which both illuminate when the wireless transmitter and the wireless receiver are powered.

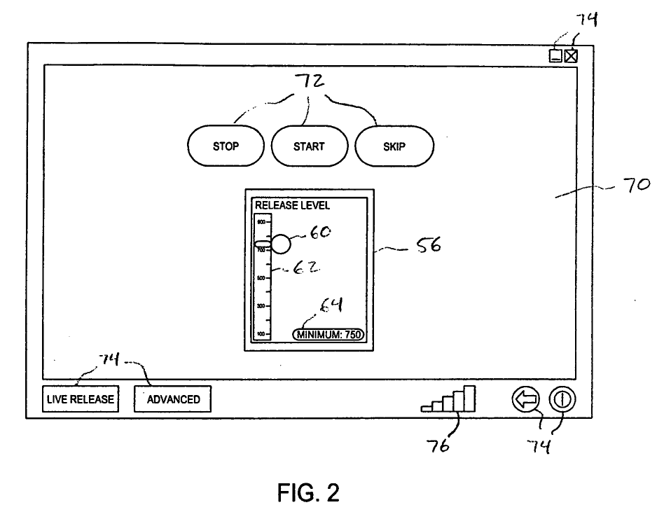

In the present example, levels of PTES derived from the signal of interest are displayed in a meter 56, (FIGS. 1 and 2), on a computer screen 58 of computer 54. In this instance, computer 54, and screen 58 displaying meter 56 serve as an indicator. Levels of detail of meter 56 can be adjusted to to suit the user. Viewing meter 56 allows user 34 to determine their level of PTES at any particular time in a manner which is objective. The objective feedback obtained from meter 56 is used for guiding the user to improve their PTES and to determine levels of PTES related to particular memories or thoughts which can be brought up in the mind of user 34 when the user is exposed to certain stimuli. Meter 56 includes an indicator 60 which moves vertically up and down a numbered bar 62 to indicated the level of the user's PTES. Meter 56 also includes a minimum level indicator 64 which indicates a minimum level of PTES achieved over a certain period of time or during a session in which user 34 is exposed to stimuli from media material 66. Meter 56 can also include the user's maximum, minimum and average levels of release during a session. Levels of PTES may also be audibly communicated to the user, and in this instance, the computer and speaker serve as the indicator. The levels can also be indicated to the user by printing them on paper.

In another instance, different release levels relating to reaction to the same media material can be stored over time on a memory device. These different release levels can be displayed next to one another to inform the user on his or her progress in releasing the negative emotions related to the media material.

In system 30, media material 66 is used to expose user 34 to stimuli designed to cause user 34 to bring up particular thoughts or emotions which are related to a high level of PTES in the user. In the present example, media material 66 includes audio material that is played though computer 54 over a speaker 68. Media material 66 and meter 56 are integrated into a computer program 70 which runs on computer 54 and is displayed on computer screen 58. Media material 66 is controlled using on-screen buttons 72, in this instance. Computer program 70 also has other menu buttons 74 for manipulation of program functions and an indicator 76 which indicates connection strength of the wireless link 50. Program 70 is typically stored in memory of computer 54, this or another memory device can also contain a database for storing self reported journals and self-observed progress.

In some instances, program 70 may require a response or other input from user 34. In these and other circumstances, user 34 may interact with program 70 using any one or more suitable peripheral or input device, such as a keyboard 78, mouse 80 and/or microphone 82. For instance, mouse 80 may be used to select one of buttons 72 for controlling media material 66.

Media material 66 allows user 34 to interact with computer 54 for self or assisted inquiry. Media material 66 can be audio, visual, audio and visual, and/or can include written material files or other types of files which are played on or presented by computer 54. Media material 66 can be based on one or more processes, such as “The Release Technique” or others. In some instances, generic topics can be provided in the form of audio-video files presented in the form of pre-described exercises. These exercises can involve typical significant life issues or goals for most individuals, such as money, winning, relationships, and many other popular topics that allow the user to achieve a freedom state regarding these topics. The freedom state about the goal can be displayed when a very low level of PTES, (under some preset threshold) is achieved by the user regarding the goal. The release technique is used as an example in some instances; other processes may also be used with the technological approach described herein.

In one instance, media material 66 involving “The Release Technique” causes user 34 to bring up a limiting emotion or an emotion-laden experience type of PTES, which results in a disturbance in the nervous system of the user. The process then guides user 34 to normalize the nervous system or release the emotion while the user is focused on the perceived cause of the disturbance. When it is determined that the level of PTES, or release level in this instance, is below a preset threshold then the process is completed.

The signal of interest which relates to the release level PTES are brain waves or electrical activity in the pre-frontal lobe of the user's brain in the range of 4-12 Hz. These characteristic frequencies of electrical activity are in the Alpha and Theta bands. Alpha band activity is in the 8 to 12 Hz range and Theta band activity is in the 4 to 7 Hz range. A linear relationship between amplitudes of the Alpha and Theta bands is an indication of the release level. When user 34 is in a non-release state, the activity is predominantly in the Theta band and the Alpha band is diminished; and when user 34 is in a release state the activity is predominantly in the Alpha band and the energy in the Theta band is diminished.

When user 34 releases the emotion, totality of thoughts that remain in the subconscious mind is lowered in the brain as the disturbance is incrementally released from the mind. A high number of thoughts in the subconscious mind results in what is known as unhappiness or melancholy feelings, which are disturbances in the nervous system. A low number of thoughts in the subconscious mind results in what is known as happiness or joyful feelings, which results in a normalization or absence of disturbances in the nervous system.

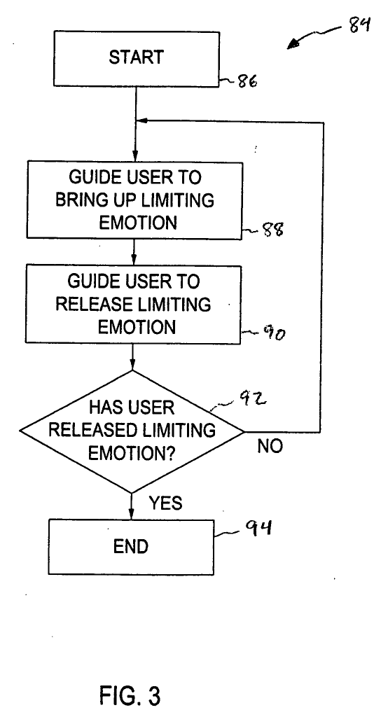

An exemplary method 84 which makes use of one or more self or assisted inquiry processes is shown in FIG. 3. Method 84 begins at a start 86 from which the method moves to a step 88. At step 88, program 70 uses stimuli in media material 66 to guide user 34 to bring up thoughts or subjects which causes an emotional disturbance in the PTES such as a limiting emotion. In the present example, media material 66 involves questions or statements directed to user 34 through speaker 68. In this and other instances, the computer can insert statements about goals or issue which were input by the user into the media material 66. For example, user 34 may input a goal statement using keyboard 78 and the computer may generate a voice which inserts the goal statement into the media material. In another example, the user may input the goal statement using microphone 82 and the computer may insert the goal statement into the media material.

Method 84 then proceeds to step 90 where program 70 uses media material 66 to guide user 34 to release the liming emotions while still focusing on the thought or subject which causes the limiting emotion. From step 90, the program proceeds to step 92 where a determination is made as to whether user 34 has released the limiting emotions. This determination is made using the signal of interest from sensor device 32. In the instance case, the level of release is indicated by the position of indicator 60 on bar 62 in meter 56, as shown in FIG. 2. If the meter indicates that user 34 has released the limiting emotions to an appropriate degree, such as below the preset threshold, then the determination at 92 is yes and method 84 proceeds to end at step 94. If the determination at 92 is that user 34 has not release the limiting emotions to an appropriate degree, then the determination at 92 is no, and method 84 returns to step 88 to again guide the user to bring up the thought or subject causing the limiting emotion. Method 84 can be continued as long as needed for user 34 to release the limiting emotions and achieve the freedom state. Processes can also include clean up sessions in which the user is guided by the media material to release many typical limiting emotions to assist the user in achieving a low thought frequency releasing the limiting emotions.

By observing meter 56 while attempting to release the limiting emotions, user 34 is able to correlate feelings with the release of limiting emotions. Repeating this process reinforces the correlation so that the user learns what it feels like to release and is able to release effectively with or without the meter 56 by having an increased releasing skill. A loop feature allows the user to click on a button to enter a loop session in which the releasing part of an exercise is repeated continuously. The levels of the user's PTES are indicated to the user and the levels are automatically recorded during these loop sessions for later review. Loop sessions provide a fast way in which to guide a user to let go of limiting emotions surrounding particular thoughts related to particular subjects. The loop session does not require the used to do anything between repetitions which allows them to maintain the desireable state of low thought activity, or the release state. Loop sessions can be included in any process for guiding the user to improve their PTES.

Computer 54 is also able to record release levels over time to a memory device to enable user 34 to review the releasing progress achieved during a recorded session. Other sessions can be reviewed along side of more recent sessions to illustrate the progress of the user's releasing ability by recalling the sessions from the memory device.

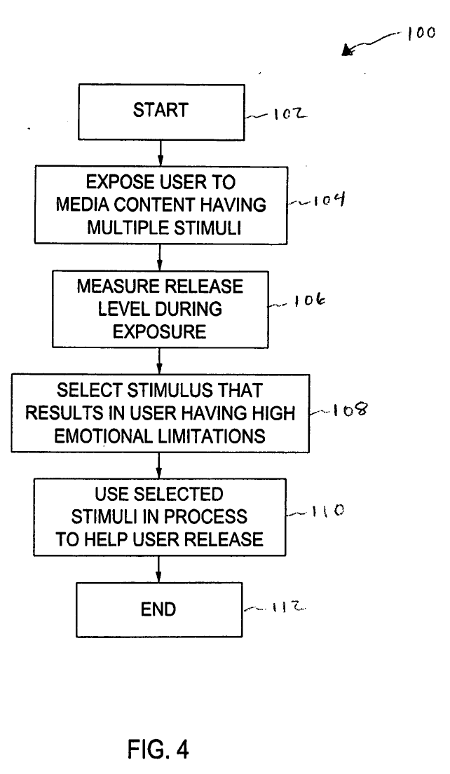

System 30 is also used for helping user 34 to determine what particular thoughts or subjects affect the user's PTES. An example of this use is a method 100, shown in FIG. 4. Method 100 begins at start 102 from which the method proceeds to step 104. At step 104, user 34 is exposed to a session of media content 42 which contains multiple stimuli that are presented to user 34 over time. Method 100 proceeds to step 106 where the levels of PTES of user 34 are determined during the session while the user is exposed to the multiple stimuli. Following step 106 method proceeds to step 108 where stimulus is selected from the media content 42 which resulted in negative affects on the PTES, such as high emotional limitations. Method 100 therefore identifies for the user areas which results in the negative affects on the PTES. Method 100 then proceeds to step 110 where the selected stimuli is used in a process to help the user release the negative emotions. Method 100 ends at step 112.

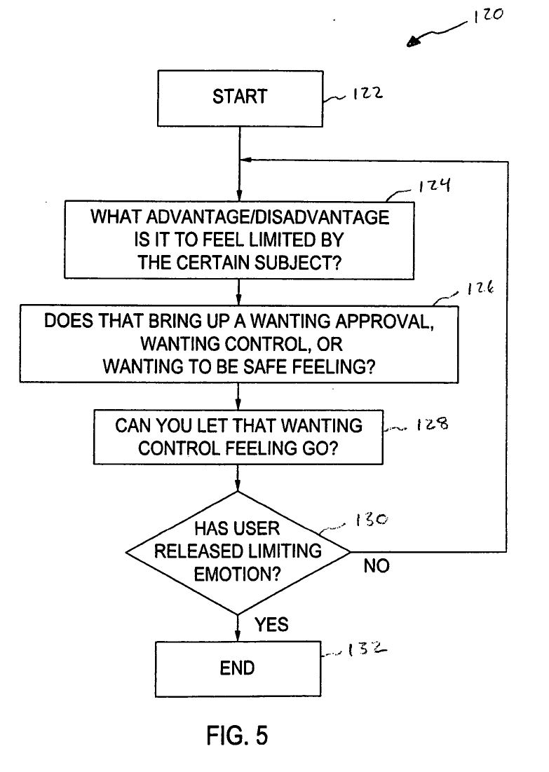

In one example, program 70 uses a method 120, FIG. 5, which includes a questioning pattern called “Advantages/Disadvantages.” In this method, the media file asks user 34 several questions in sequence related to advantages/disadvantages of a “certain subject”, which causes the user to experience negative emotions. Words or phrases of the “certain subject” can be entered into the computer by the user using one of the input devices, such as keyboard 78, mouse 80 and/or microphone 82 which allows the computer to insert the words or phrases into the questions. System 30 may also have goal documents that have the user's goal statements displayed along with the questioning patterns about the goal and release level data of the user regarding the goal. As an example, the user may have an issue which relates to control, such as a fear of being late for an airline flight. In this instance, the user would enter something like “fear of being late for a flight” as the “certain subject.”

Series of questions related to advantages and disadvantage can be alternated until the state of release, or other PTES, is stabilized as low as possible, that is with the greatest amount of release. Method 120, shown in FIG. 5, starts at a start 122 from which it proceeds to step 124 where program 70 asks user 34 “What advantage/disadvantage is it to me to feel limited by the certain subject?” Program 70 then waits for feedback from the user through one of the input devices.

Program then proceeds to step 126 where program 70 asks user 34 “Does that bring up a wanting approval, wanting control or wanting to be safe feeling?” Program 70 waits for a response from user 34 from the input device and deciphers which one of the feelings the user responds with, such as “control feeling” for instance. Method 120 then proceeds to step 128 where program 70 questions the user based on the response given to step 128 by asking “Can you let that wanting control feeling go?” in this instance. At this point method 120 proceeds to step 130 where sensor device 32 determines the signal of interest to determine the release level of user 34. The release level is monitored and the media file stops playing when the release level has stabilized at its lowest point. At this time method 120 proceeds to step 32 and the session is complete. When the session is complete, user 34 will feel a sense of freedom regarding the certain subject. If some unwanted emotional residue is left, this same process can be repeated until complete freedom regarding the issue is realized by the user.

The above method is an example of “polarity releasing” in which an individual is guided to think about positives and negatives about a certain subject or particular issue, until the mind gives up on the negative emotions generated by the thoughts. There are other polarity releasing methods, such as “Likes/Dislikes” and other concepts and methods that help user's to achieve lower though frequency which may also be used along with a sensor device such as sensor device 32 for the purposes described herein.

Program 70 can store the history of responses to media on a memory device, and combine multiple iterations of responses to the same media in order to create a chart of improvement for user 34. Plotting these responses on the same chart using varying colors and dimensional effects demonstrates to user 34 the various PTES reactions over time to the same media stimulus, demonstrating improvement.

Program 70 can store reaction to live content as well. Live content can consist of listening to a person or audio in the same physical location, or listening to audio streaming over a telecommunications medium like telephone or the Internet, or text communications. Program 70 can send the PTES data from point-to-point using a communication medium like the Internet. With live content flowing in one direction, and PTES data flowing in the other, the deliverer of live content has a powerful new ability to react and change the content immediately, depending on the PTES data reaction of the individual. This deliverer may be a person or a web server application with the ability to understand and react to changing PTES.

Program 70 can detect the version of the electronic module 40 latently, based on the type of data and number of bytes being sent. This information is used to turn on and off various features in the program 70, depending on the feature's availability in the electronic module 40.

With certain types of computers and when certain types of wireless links are used, an incompatibility between wireless receiver 48 and computer 54 may occur. This incompatibility between an open host controller interface (OHCI) of the computer 54 and a universal host controller interface (UHCI) chip in the wireless receiver 48 causes a failure of communication. Program 70 has an ability to detect the symptom of this specific incompatibility and report it to the user. The detection scheme looks for a single response to a ping ‘P’ from the wireless receiver 48, and all future responses to a ping are ignored. Program 70 then displays a modal warning to the user suggesting workarounds for the incompatibility.

Program 70 detects the disconnecting of wireless link 50 by continually checking for the arrival of new data. If new data stops coming in, it assumes a wireless link failure, and automatically pauses the media being played and recording of PTES data. On detection of new data coming into the computer 54, the program 70 automatically resumes the media and recording.

Program 70 can create exercises and set goals for specific PTES levels. For example, it asks the user to set a target level of PTES and continues indefinitely until the user has reached that goal. Program 70 can also store reactions during numerous other activities. These other activities include but are not limited to telephone conversations, meetings, chores, meditation, and organizing. In addition, program 70 can allow users to customize their sessions by selecting audio, title, and length of session.

Other computing devices, which can include processor based computing devices, (not shown) can be used with sensor device 32 to play media material 66 and display or otherwise indicate the PTES. These devices may be connected to the sensor device 32 utilizing an integrated wireless receiver rather than the separate wireless receiver 48 which plugs into the port of the computer. These devices are more portable than computer 54 which allows the user to monitor the level PTES throughout the day or night which allows the user to liberate the subconscious mind more rapidly. These computing devices can include a camera with an audio recorder for storing and transmitting data to the receiver to store incidents of reactivity on a memory device for review at a later time. These computing devices can also upload reactivity incidents, intensity of these incidents and/or audio-video recordings of these incidents into computer 54 where the Attachment and Aversions process or other process can be used to permanently reduce or eliminate reactivity regarding these incidents.

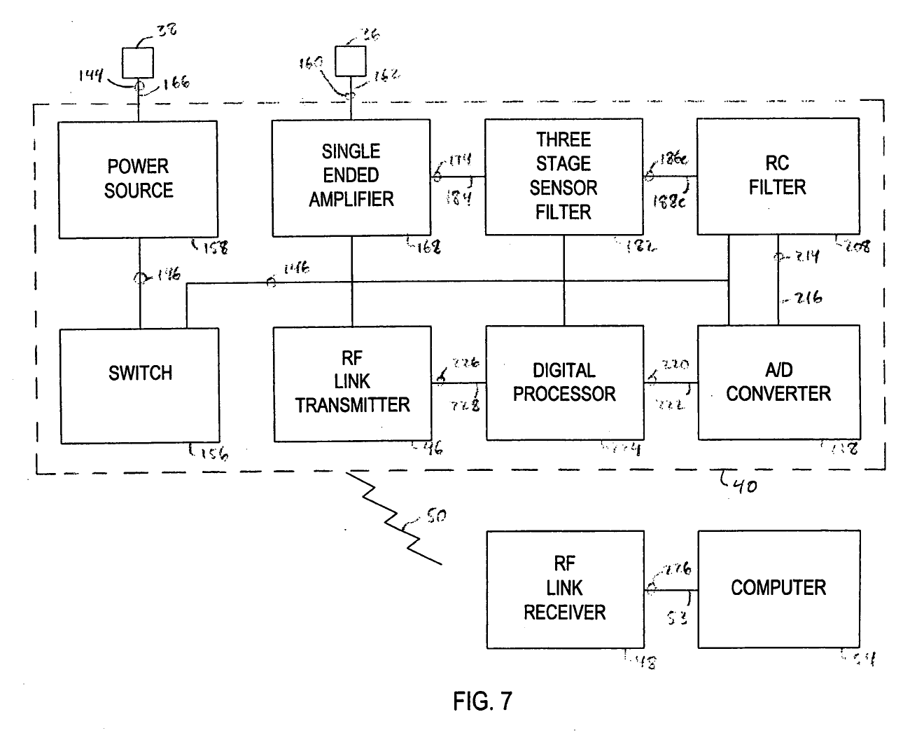

One example of sensor device 32 is shown in FIGS. 6 and 7. Sensor device 32 includes sensor electrode 36, reference electrode 38 and electronics module 40. The electronics module 40 amplifies the signal of interest by 1,000 to 100,000 times while at the same time insuring that 60 Hz noise is not amplified at any point. Electronics module 40 isolates the signal of interest from undesired electrical activity.

Sensor device 32 in the present example also includes wireless receiver 48 which receives the signal of interest from the electronics module over wireless link 50 and communicates the signal of interest to computer 54. In the present example, wireless link 50 uses radiofrequency energy; however other wireless technologies may also be used, such as infrared. Using a wireless connection eliminates the need for wires to be connected between the sensor device 32 and computer 54 which electrically isolates sensor device 32 from computer 54.

Reference electrode 38 is connected to a clip 148 which is used for attaching reference electrode 38 to an ear 150 of user 34, in the present example. Sensor electrode 36 includes a snap or other spring loaded device for attaching sensor electrode 36 to headband 42. Headband 42 also includes a pocket for housing electronics module 40 at a position at the user's temple. Headband 42 is one example of an elastic band which is used for holding the sensor electrode and/or the electronics module 40, another types of elastic bands which provide the same function could also be used, including having the elastic band form a portion of a hat.

Other types of mounting devices, in addition to the elastic bands, can also be used for holding the sensor electrode against the skin of the user. A holding force holding the sensor electrode against the skin of the user can be in the range of 1 to 4 oz. The holding force can be, for instance, 1.5 oz.

In another example of a mounting device involves a frame that is similar to an eyeglass frame, which holds the sensor electrode against the skin of the user. The frame can also be used for supporting electronics module 40. The frame is worn by user 34 in a way which is supported by the ears and bridge of the nose of the user, where the sensor electrode 36 contacts the skin of the user.

Sensor electrode 36 and reference electrode 38 include conductive surface 152 and 154, respectively, that are used for placing in contact with the skin of the user at points where the measurements are to be made. In the present example, the conductive surfaces are composed of a non-reactive material, such as copper, gold, conductive rubber or conductive plastic. Conductive surface 152 of sensor electrode 36 may have a surface area of approximately ½ square inch. The conductive surfaces 152 are used to directly contact the skin of the user without having to specially prepare the skin and without having to use a substance to reduce a contact resistance found between the skin and the conductive surfaces.

Sensor device 32 works with contact resistances as high as 500,000 ohms which allows the device to work with conductive surfaces in direct contact with skin that is not specially prepared. In contrast, special skin preparation and conductive gels or other substances are used with prior EEG electrodes to reduce the contact resistances to around 20,000 ohms or less. One consequence of dealing with higher contact resistance is that noise may be coupled into the measurement. The noise comes from lights and other equipment connected to 60 Hz power, and also from friction of any object moving through the air which creates static electricity. The amplitude of the noise is proportional to the distance between the electronics module 40 and the reference electrode 38. In the present example, by placing the electronics module over the temple area, right above the ear and connecting the reference electrode to the ear, the sensor device 32 does not pick up the noise, or is substantially unaffected by the noise. By positioning the electronics module in the same physical space with the reference electrode and capacitively coupling the electronics module with the reference electrode ensures that a local reference potential 144 in the electronics module and the ear are practically identical in potential. Reference electrode 38 is electrically connected to local reference potential 144 used in a power source 158 for the sensor device 32.

Power source 158 provides power 146 to electronic components in the module over power conductors. Power source 158 provides the sensor device 32 with reference potential 144 at 0 volts as well as positive and negative source voltages, −VCC and +VCC. Power source 158 makes use of a charge pump for generating the source voltages at a level which is suitable for the electronics module.

Power source is connected to the other components in the module 40 though a switch 156. Power source 158 can include a timer circuit which causes electronics module 40 to be powered for a certain time before power is disconnected. This feature conserves power for instances where user 34 accidentally leaves the power to electronics module 40 turned on. The power 146 is referenced locally to measurements and does not have any reference connection to an external ground system since sensor circuit 32 uses wireless link 50.

Sensor electrode 36 is placed in contact with the skin of the user at a point where the electrical activity in the brain is to be sensed or measured. Reference electrode 38 is placed in contact with the skin at a point a small distance away from the point where the sensor electrode is placed. In the present example, this distance is 4 inches, although the distance may be as much as about 8 inches. Longer lengths may add noise to the system since the amplitude of the noise is proportional to the distance between the electronics module and the reference electrode. Electronics module 40 is placed in close proximity to the reference electrode 38. This causes the electronics module 40 to be in the same of electrical and magnetic environment is the reference electrode 38 and electronics module 40 is connected capacitively and through mutual inductance to reference electrode 38. Reference electrode 38 and amplifier 168 are coupled together into the noise environment, and sensor electrode 36 measures the signal of interest a short distance away from the reference electrode to reduce or eliminate the influence of noise on sensor device 32. Reference electrode 38 is connected to the 0V in the power source 158 with a conductor 166.

Sensor electrode 36 senses electrical activity in the user's brain and generates a voltage signal 160 related thereto which is the potential of the electrical activity at the point where the sensor electrode 36 contacts the user's skin relative to the local reference potential 144. Voltage signal 160 is communicated from the electrode 36 to electronics module 40 over conductor 162. Conductors 162 and 166 are connected to electrodes 36 and 38 in such a way that there is no solder on conductive surfaces 152 and 154. Conductor 162 is as short as practical, and in the present example is approximately 3 inches long. When sensor device 32 is used, conductor 162 is held a distance away from user 34 so that conductor 162 does not couple signals to or from user 34. In the present example, conductor 162 is held at a distance of approximately ½″ from user 34. No other wires, optical fibers or other types of extensions extend from the electronics module 40, other than the conductors 162 and 166 extending between module 40 and electrodes 36 and 38, since these types of structure tend to pick up electronic noise.

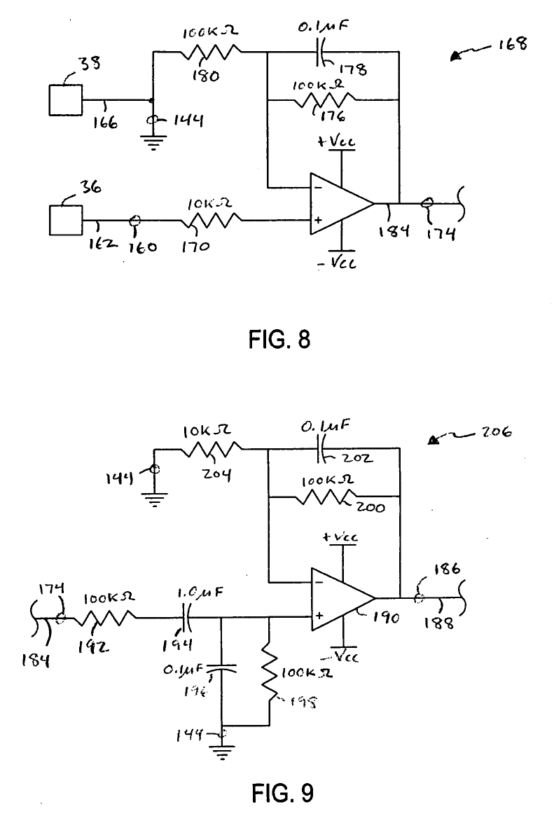

The electronics module 40 measures or determines electrical activity, which includes the signal of interest and other electrical activity unrelated to the signal of interest which is undesired. Electronics module 40 uses a single ended amplifier 168, (FIGS. 7 and 8), which is closely coupled to noise in the environment of the measurement with the reference electrode 38. The single ended amplifier 168 provides a gain of 2 for frequencies up to 12 Hz, which includes electrical activity in the Alpha and Theta bands, and a gain of less than 1 for frequencies 60 Hz and above, including harmonics of 60 Hz.

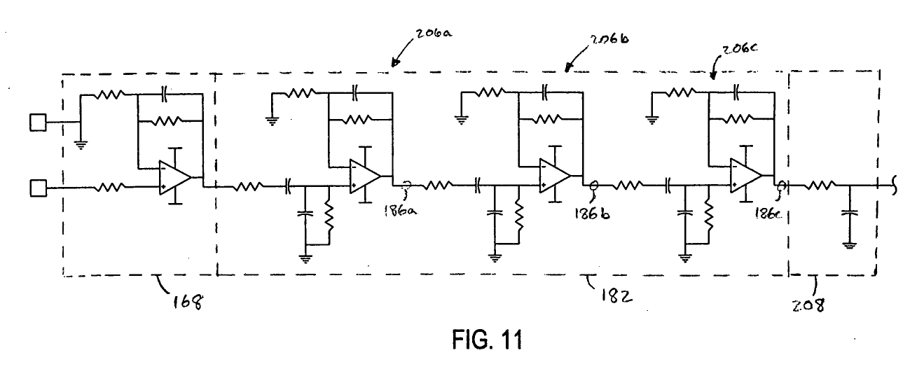

Amplifier 168, FIGS. 8 and 11, receives the voltage signal 160 from electrode 36 and power 146 from power source 158. Single ended amplifier 168 generates an output signal 174 which is proportional to voltage signal 160. Output signal 174 contains the signal of interest. In the present example, voltage signal 160 is supplied on conductor 162 to a resistor 170 which is connected to non-inverting input of high impedance, low power op amp 172. Output signal 174 is used as feedback to the inverting input of op amp 172 through resistor 176 and capacitor 178 which are connected in parallel. The inverting input of op amp 172 is also connected to reference voltage 144 through a resistor 180.

Amplifier 168 is connected to a three-stage sensor filter 182 with an output conductor 184 which carries output signal 174. The electrical activity or voltage signal 160 is amplified by each of the stages 168 and 182 while undesired signals, such as those 60 Hz and above, are attenuated by each of the stages. Three-stage sensor filter has three stages 206a, 206b and 206c each having the same design to provide a bandpass filter function which allows signals between 1.2 and 12 Hz to pass with a gain of 5 while attenuating signal lower and higher than these frequencies. The bandpass filter function allows signals in the Alpha and Theta bands to pass while attenuating noise such as 60 Hz and harmonics of the 60 Hz. The three stage sensor filter 182 removes offsets in the signal that are due to biases and offsets in the parts. Each of the three stages is connected to source voltage 146 and reference voltage 144. Each of the three stages generates an output signal 186a, 186b and 186c on an output conductor 188a, 186b and 188c, respectively.

In the first stage 206a, FIGS. 9 and 11, of three-stage sensor filter 182, output signal 174 is supplied to a non-inverting input of a first stage op-amp 190a through a resistor 192a and capacitor 194a. A capacitor 196a and another resistor 198a are connected between the non-inverting input and reference voltage 144. Feedback of the output signal 186a from the first stage is connected to the inverting input of op amp 190a through a resistor 200a and a capacitor 202a which are connected in parallel. The inverting input of op amp 190a is also connected to reference voltage 144 through resistor 204a.

Second and third stages 206b and 206c, respectively, are arranged in series with first stage 206a. First stage output signal 186a is supplied to second stage 206b through resistor 192b and capacitor 194b to the non-inverting input of op-amp 190b. Second stage output signal 186b is supplied to third stage 206c through resistor 192c and capacitor 194c. Resistor 198b and capacitor 196b are connected between the non-inverting input of op-amp 190b and reference potential 144, and resistor 198c and capacitor 196c are connected between the non-inverting input of op-amp 190c and reference potential 144. Feedback from output conductor 188b to the inverting input of op-amp 190b is through resistor 200b and capacitor 202b and the inverting input of op-amp 190b is also connected to reference potential 144 with resistor 204b. Feedback from output conductor 188c to the inverting input of op-amp 190c is through resistor 200c and capacitor 202c and the inverting input of op-amp 190c is also connected to reference potential 144 with resistor 204c.

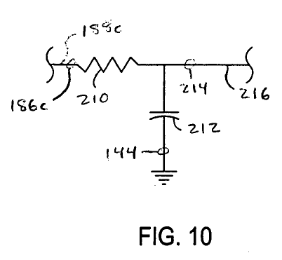

Three stage sensor filter 182 is connected to an RC filter 208, FIGS. 10 and 11, with the output conductor 188c which carries the output signal 186c from third stage 206c of three stage sensor filter 182, FIG. 7. RC filter 208 includes a resistor 210 which is connected in series to an output conductor 216, and a capacitor 212 which connects between reference potential 144 and output conductor 216. RC filter serves as a low pass filter to further filter out frequencies above 12 Hz. RC filter 208 produces a filter signal 214 on output conductor 216. RC filter 208 is connected to an analog to digital (A/D) converter 218, FIG. 7.

A/D converter 218 converts the analog filter signal 214 from the RC filter to a digital signal 220 by sampling the analog filter signal 214 at a sample rate that is a multiple of 60 Hz. In the present example the sample rate is 9600 samples per second. Digital signal 220 is carried to a digital processor 224 on an output conductor 222.

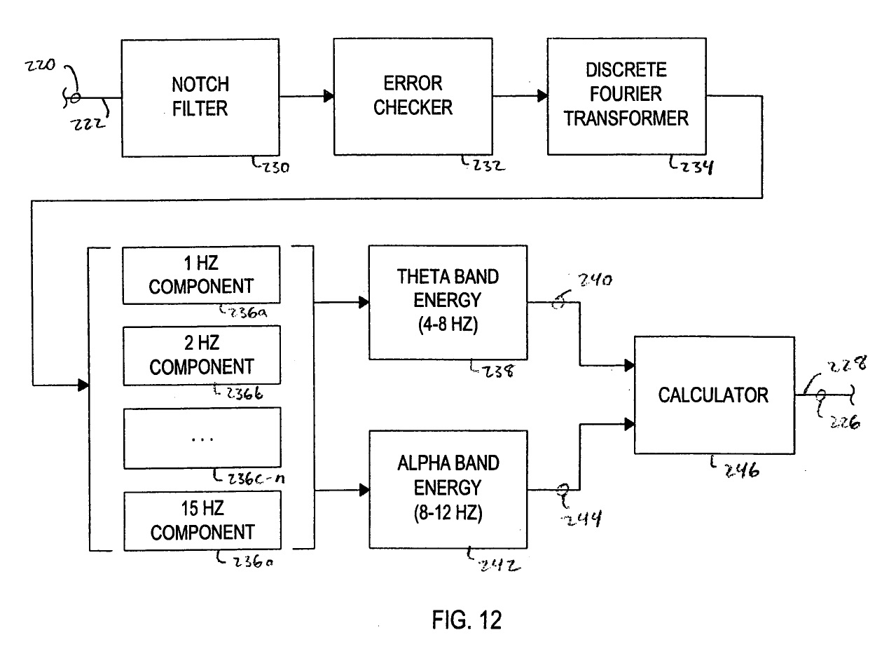

Digital processor 224, FIG. 7 and 12 provides additional gain, removal of 60 Hz noise, and attenuation of high frequency data. Digital processor 224 many be implemented in software operating on a computing device. Digital processor 224 includes a notch filter 230, FIG. 12 which sums 160 data points of digital signal 220 at a time to produce a 60 Hz data stream that is free from any information at 60 Hz. Following notch filter 230 is an error checker 232. Error checker 232, removes data points that are out of range from the 60 Hz data stream. These out of range data points are either erroneous data or they are cause by some external source other than brain activity.

After error checker 232, digital processor 224 transforms the data stream using a discreet Fourier transformer 234. While prior EEG systems use band pass filters to select out the Alpha and Theta frequencies, among others, these filters are limited to processing and selecting out continuous periodic functions. By using a Fourier transform, digital processor 224 is able to identify randomly spaced events. Each event has energy in all frequencies, but shorter events will have more energy in higher frequencies and longer events will have more energy in lower frequencies. By looking at the difference between the energy in Alpha and Theta frequencies, the system is able to identify the predominance of longer or shorter events. The difference is then scaled by the total energy in the bands. This causes the output to be based on the type of energy and removes anything tied to amount of energy.

The Fourier transformer 234 creates a spectrum signal that separates the energy into bins 236a to 236o which each have a different width of frequency. In one example, the spectrum signal has 30 samples and separates the energy spectrum into 2 Hz wide bins; in another example, the spectrum signal has 60 samples and separates the bins into 1 Hz wide bins. Bins 236 are added to create energy signals in certain bands. In the present example, bins 236 between 4 and 8 Hz are passed to a summer 238 which sums these bins to create a Theta band energy signal 240; and bins between 8 and 12 Hz are passed to a summer 242 which sums these bins to create an Alpha band energy signal 244.

In the present example, the Alpha and Theta band energy signals 240 and 244 passed to a calculator 246 which calculates (Theta−Alpha)/Theta+Alpha) and produces an output signal 226 on a conductor 228 as a result.

Output signal 226, FIG. 7, is passed to wireless transmitter 46 which transmits the output signal 226 to wireless receiver 48 over wireless link 50. In the present example, output signal 226 is the signal of interest which is passed to computer 54 through port 52 and which is used by the computer to produce the PTES for display in meter 56.

Computer 54 may provide additional processing of output signal 226 in some instances. In the example using the Release Technique, the computer 54 manipulates output signal 226 to determine relative amounts of Alpha and Theta band signals in the output signal to determine levels of release experienced by user 34.

A sensor device utilizing the above described principles and feature can be used for determining electrical activity in other tissue of the user in addition to the brain tissue just described, such as electrical activity in muscle and heart tissue. In these instances, the sensor electrode is positioned on the skin at the point where the electrical activity is to be measured and the reference electrode and electronics module are positioned nearby with the reference electrode attached to a point near the sensor electrode. The electronics module, in these instances, includes amplification and filtering to isolate the frequencies of the muscle or heart electrical activity while filtering out other frequencies.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for use by a given user, said method comprising:
(a) predefining a measurable characteristic of electrical activity (MCEA) in the pre-frontal lobe of the given user's brain that measurably corresponds to a level of certain present time emotional state of the given user;
(b) isolating the MCEA from other electrical activity in the given user's brain;
(c) providing media material which when interacted with by the given user in a particular way can change the present time emotional state of the user in a way which correspondingly changes the MCEA;
(d) causing the user to interact with the media material in said particular way; and
(e) as said user interacts with the media in said particular way, measuring changes in the user's MCEA, if any.

2. A method as defined in claim 1, further comprising:
providing the user with the changes in his or her MCEA, and
thereafter, causing the user to continue interaction with the media in a way which causes the MCEA to change.

3. A method as defined in claim 1 wherein the certain present time emotional state is related to releasing of limiting emotions of the user.

4. A method as defined in claim I wherein the MCEA isolated from other electrical activity includes Alpha and Theta brain waves.

5. A method as defined in claim 1 wherein the media material includes material from The Release Technique.

6. A method as defined in claim 1 wherein measuring changes in user's MCEA using an isolated single ended amplifier sensor circuit.

7. A system for use by a given user in which there is established a predefined measurable characteristic of electrical activity (MCEA) in the pre-frontal lobe of the given user's brain that measurably corresponds to a level of certain present time emotional state of the given user, said system comprising:
(a) media material which when interacted with by the given user in a particular way can change the present time emotional state of the user in a way which correspondingly changes the MCEA;
(b) means for isolating the MCEA from other electrical activity in the given user's brain; and
(c) means for measuring changes in the given user's MCEA, if any, as he or she interacts with the media in said particular way.

8. A system as defined in claim 7 wherein the media material includes audio formatted material.

9. A system as defined in claim 7 wherein the media material includes video formatted material.

10. A system as defined in claim 7 wherein the media material includes material from The Release Technique.

11. A system as defined in claim 7 wherein changes in the user's MCEA are communicated to the user.

12. In a system which involves using media material for guiding a human user to release limiting emotions experienced by the user when the user thinks particular thoughts which causes the user to experience emotional pain, where the release is characterized by different levels which are based on how strongly the user experiences the limiting emotions when confronted with the particular thoughts, and where the user has a greater release level when the user has less limiting emotions related to the particular thoughts and the user has lower release levels when the user has more limiting emotions related to the particular thoughts, a method comprising:
predefining an association between a characteristic of electrical activity in a pre-frontal lobe of a human brain and levels of release that are being experienced;
exposing the user to a stimulus from the media material relating to the particular thoughts at a particular time which causes the user to experience a particular one or more of the limiting emotions;
determining the characteristic of electrical activity in the user's brain at the particular time to establish the level of release at the particular time; and
indicating the determined release level to the user.

13. A method as defined in claim 12 wherein determining the characteristic of the electrical activity includes determining a relationship between Alpha and Theta band electrical activity in the pre-frontal lobe of the user.

14. A method as defined in claim 12 wherein determining the characteristic of the electrical activity includes determining amounts of Alpha and Theta band electrical activity in the pre-frontal lobe of the user.

15. A method as defined in claim 14 wherein determining the characteristic of the electrical activity includes determining an amount of the Alpha band electrical activity in proportion to an amount of the Theta band electrical activity.

16. A method as defined in claim 14 wherein determining the amounts of Alpha and Theta band electrical activity includes coupling a reference electrode and amplifier into a single coupled noise environment and measuring the Alpha and Theta band electrical activity at a short distance relative to the reference electrode.

17. A method as defined in claim 14 wherein coupling the reference electrode includes connecting the reference electrode to the right ear of the user.

18. A method as defined in claim 12 wherein the determined release level is visually indicated to the user.

19. A method as defined in claim 12 wherein the determined release level is audibly indicated to the user.

20. A method as defined in claim 12 wherein the media material includes a pre-recorded file that guides the user to respond to the stimulus in the media material by bringing up thoughts which cause limiting emotions and releasing the limiting emotions on a repeated basis, and the amount of electrical activity in the user's brain is repeatedly determined until the release level reaches a predefined level.

21. A method as defined in claim 12 wherein the user is exposed to a series of multiple stimuli in a session which lasts for a session time, and the release level is determined multiple times during the session.

22. A method as defined in claim 21 wherein the release level is indicated to the user during the session to allow the user to review changes in the release level during the session.

23. A method as defined in claim 21 wherein the user is exposed to multiple sessions and the release levels of one session are compared with the release levels of another session to indicate changes in release levels to the user.

24. A method as defined in claim 12 wherein the user is exposed to a series of multiple different stimuli during a session and the release level is monitored during the session to determine which of the different stimuli cause the user to experience greater release levels and which of the different stimuli cause the user to experience lower release levels.

25. A method as defined in claim 24 wherein the user is repeatedly exposed to the stimulus determined to cause the user to experience lower release levels until the user experiences higher release levels.

26. A method as defined in claim 12, further comprising:
indicating to the user when a certain release level is reached.

27. A method as defined in claim 26, further comprising:
discontinuing the exposure of the user to the media material when the certain release level is reached.

28. A method as defined in claim 12, further comprising:
electronically communicating the user's release level to a teacher; and
providing a communication connection between the user and the teacher to allow the teacher to interact with the user while observing the user's release level.

29. In a system which involves using media material for guiding a human user to release limiting emotions experienced by the user when the user thinks particular thoughts which causes the user to experience emotional pain, where the release is characterized by different levels which are based on how strongly the user experiences the limiting emotions when confronted with the particular thoughts, and where the user has a greater release level when the user has less limiting emotions related to the particular thoughts and the user has lower release levels when the user has more limiting emotions related to the particular thoughts, an apparatus comprising:
a memory device for storing a predefined association between a characteristic of electrical activity in a pre-frontal lobe of a human brain, and levels of release that are being experienced;
a sensor circuit for sensing the characteristic of electrical activity in a pre-frontal lobe of the user's brain and for generating a signal of interest based on the sensed characteristic and for transmitting the signal of interest;
a processor connected to receive the signal of interest from the sensor circuit and the association from the memory device and to generate a release level signal based on the application of the association to the signal of interest; and
an indicator for receiving the release level signal and indicating the release level to the user.

30. An apparatus as defined in claim 29 wherein release level is visually indicated to the user and the indicator allows the user to control and modify the media material and the appearance of the release level indication.

31. An apparatus as defined in claim 29 wherein the sensor circuit is worn on the user's head and the processor receives the signal of interest through a wireless link.

32. An apparatus as defined in claim 29 wherein the indicator includes a speaker for audibly indicating the release level to the user.

33. An apparatus as defined in claim 29 wherein the indicator includes a visual screen for visually indicating the release level to the user.

34. An apparatus as defined in claim 29 wherein the media material includes a pre-recorded file that guides the user to respond to stimulus in the media material by bringing up thoughts which cause limiting emotions, and where processor is used to present the media material to the user.

35. An apparatus as defined in claim 34 wherein the media material involves The Release Technique.

36. An apparatus as defined in claim 29 wherein the sensor circuit includes a sensor conductive surface that is used to contact the skin of the user at a position to sense the characteristic of electrical activity in the pre-frontal lobe of the user's brain, wherein the characteristic includes characteristics of Alpha and Theta band electrical activity, the sensor circuit further including a series of amplification stages and filter stages for isolating the Alpha and Theta band electrical activity from unwanted electrical activity, where the series includes a first stage single ended amplifier and the sensor conductive surface is electrically connected to the first stage single ended amplifier.

37. An apparatus as defined in claim 36 wherein the sensor circuit includes a reference conductive surface which determines an environmental noise signal from environmental noise surrounding the sensor circuit and the single ended amplifier amplifies the Alpha and Theta band electrical activity relative to the environmental noise signal in a manner where the environmental noise is not amplified.

38. An apparatus as defined in claim 36 wherein the first stage single ended amplifier also serves as a low pass filter which reduces gain of frequencies above 12 Hz.

39. An apparatus as defined in claim 29 wherein the processor receives the signal of interest from the sensor circuit over a wireless link.

40. An apparatus as defined in claim 39 wherein the processor generates an error signal if the wireless link fails.

41. An apparatus as defined in claim 40 wherein the media material is played for guiding the user to release the limiting emotions, and the media material is paused when the processor generates the error signal.

42. An apparatus as defined in claim 29 wherein the processor determines communication compatibility between the sensor circuit and the processor.

43. An apparatus as defined in claim 42 wherein the sensor circuit includes a wireless receiver which communicates based on UHCI USB circuitry and the processor communicates based on OHCI USB control circuitry.

44. An apparatus as defined in claim 29 wherein the sensor circuit has versions and the processor determines the version of the sensor circuit.

45. An apparatus as defined in claim 44 wherein signal of interest transmitted from the sensor circuit includes a certain range and the signal of interest is transmitted at a certain transmission rate, and wherein the processor determines the version of the sensor circuit based on the transmission rate and range of the signal of interest.

46. An apparatus as defined in claim 29 wherein the processor is configured to receive a plurality of signal of interests from a plurality of different sensor circuits.

47. An apparatus as defined in claim 29 wherein the processor is configured to communicate over a computer network.

48. An apparatus as defined in claim 47 wherein the processor communicates information relating to the signal of interest over the computer network.

49. An apparatus as defined in claim 29 wherein the processor is configured to allow the user to communicate over a network to other users.

50. An apparatus as defined in claim 49 wherein the communication to other users is through one of text, video or audio.

51. An apparatus as defined in claim 29 wherein there is a plurality of media material, and one of which is played at a time to cause the user to generate electrical activity in response, and the processor is configured to determine which of the media material is played based on the sensor signal.

52. An apparatus as defined in claim 29 wherein the processor is configured to store the levels of release as it relates to the media material on the memory device..

53. An apparatus as defined in claim 29 wherein the processor is configured to access the memory device and communicate the stored levels of release and related media material to the user.

54. An apparatus as defined in claim 53 wherein the processor is configured to repeatedly communicated the stored levels of release and related material to the user until the user interacts with the processor to discontinue the communication.

55. An apparatus as defined in claim 29 wherein the memory device is configured with a database for storing self-reported journals and self-observed progress.

56. An apparatus as defined in claim 29 wherein the indicator visually indicates the levels of release stored in the memory device.

57. An apparatus as defined in claim 29 wherein the indicator visually indicates the user's maximum, minimum and average levels of release during a session.

58. An apparatus as defined in claim 29 wherein the indicator visually indicates the release level and the visual indication has levels of detail which are adjustable.

59. An apparatus as defined in claim 29 wherein the indicator indicates the release level by printing the release level on paper.
